(19) United States
(12) Patent Application Publication
(10) Pub. No.: US 2026/0313619 A1
(43) Pub. Date: Oct. 8, 2026

(54) RANK AUGMENTATION BY WIRELESS RELAY

(71) Applicant: MEDIATEK INC., Hsinchu City (TW)

(72) Inventors: WEI-KAI CHANG, Hsinchu City (TW); Lung-Sheng TSAI, Hsinchu City (TW)

(21) Appl. No.: 19/481,205

(22) PCT Filed: May 23, 2024
(86) PCT No.: PCT/CN2024/094867

§ 371 Date: Nov. 4, 2025

Related U.S. Application Data
(60) Provisional application No. 63/503,731, filed on May 23, 2023.

(51) Int. Cl. H04W 72/0446; H04L 5/00; H04W 72/0453

(52) U.S. Cl. CPC H04W 72/0446; H04L 5/0012; H04W 72/0453

(57) ABSTRACT

a method for a User Equipment (UE) to receive data is provided. The method comprises receiving an indication indicating the UE to receive a first RF signal carrying L layers of data on a first time-frequency resource occupying a first bandwidth, wherein L is a positive integer, and to receive K second RF signals each carrying the L layers of data respectively on K sets of non-overlapped second time-frequency resources occupying at least K times the first bandwidth, wherein K is a positive integer greater than 1; receiving, based on the indication, the first RF signal at one or more first receiving antennas on the first time-frequency resource and the K second RF signals at one or more second receiving antennas respectively on the K sets of non-overlapped second time-frequency resources; obtaining a first baseband signal from the first RF signal and K second baseband signals from the K second RF signals; and determining the L layers of data based on the first baseband signal and the K second baseband signals.

### CROSS-REFERENCE TO RELATED APPLICATIONS

The present application claims the benefit of U.S. Provisional Patent Application Ser. No. 63/503,731 filed on May 23, 2023, the entire disclosure of which is incorporated herein in its entirety by reference.

### BACKGROUND OF THE INVENTION

### 1. Field of the Invention

This disclosure generally relates to a wireless communication network, and more particularly, to a method, device and system for augmenting Ranks in a wireless communication network.

### 2. Description of Related Art

In a typical mobile communication environment, a User Equipment (UE) (also called as a Mobile Station (MS)), such as a mobile phone (also known as a cellular phone or cell phone), or a tablet Personal Computer (PC) with wireless communication capability may communicate voice and/or data signals with a wireless communication network. The wireless communication between the UE and the wireless communication network may be performed using various Radio Access Technologies (RATs), such as, Long Term Evolution (LTE) technology, LTE-Advanced (LTE-A) technology, and New Radio (NR) technology etc. In particular, LTE/LTE-A/TD-LTE technology is also called 4G technology; and NR technology is also called 5G technology.

In 4G/5G systems, a technique called Multiple-Input-Multiple-Output (MIMO) is used to increase the data throughput by using multiple transmitter antennas and multiple receiver antennas. Generally speaking, MIMO can be referred to as the ability to transmit multiple data streams (or called “layers”), using the same time and frequency resource, where each data stream can be beamformed. MIMO builds on the basic principle that when the received signal quality is high, it is better to receive multiple streams of data with reduced power per stream, than one stream with full power. The potential is especially large when the received signal quality is high and the streams do not interfere with each other.

In 4G/5G systems, a wireless relay that can be used to assist indirect communications between two nodes, for example a UE and a Base Station, is usually equipped with a smaller number of transmitter antennas than that of receiver antennas, for example 2 receiver antennas and 1 transmitter antenna (2R1T). As a result, when the wireless relay forwards data to the UE, such as a mobile phone, the RANK improvement associated with a channel matrix between the two nodes is limited to the number of the transmitter antennas of the wireless relay, which is 1 in the 2R1T system. It brings inefficiency. Therefore, it is desirable to have methods, devices and/or systems to augment RANK with the assistance of the wireless relay so as to efficiently utilize the bandwidth of the wireless relay.

### SUMMARY OF THE INVENTION

In one aspect of the present disclosure, a method for a User Equipment (UE) to receive data is provided. The method comprises receiving an indication indicating the UE to receive a first RF signal carrying L layers of data on a first time-frequency resource occupying a first bandwidth, wherein L is a positive integer, and to receive K second RF signals each carrying the L layers of data respectively on K sets of non-overlapped second time-frequency resources occupying at least K times the first bandwidth, wherein K is a positive integer greater than 1; receiving, based on the indication, the first RF signal at one or more first receiving antennas on the first time-frequency resource and the K second RF signals at one or more second receiving antennas respectively on the K sets of non-overlapped second time-frequency resources; obtaining a first baseband signal from the first RF signal and K second baseband signals from the K second RF signals; and determining the L layers of data based on the first baseband signal and the K second baseband signals.

In one aspect of the present disclosure, a method for a wireless device to receive and transmit data by using Nr receiving antennas and Nt transmitting antennas, wherein Nr and Nt are positive integers, is provided. The method comprises receiving one RF signal at each of the Nr receiving antennas on a first time-frequency resource, wherein the one RF signal on the first time-frequency resource carries a baseband data signal occupying a first bandwidth for carrying L layers of data generated at a node, and the L is a positive integer; and transmitting another Nt RF signals at the Nt transmitting antennas on a second time-frequency resource, wherein the another Nt RF signals at the Nt transmitting antennas comprises K sets of component RF signals, wherein K is an integer greater than 1, and each of the K sets of component RF signals occupies a third time-frequency resource of a second bandwidth no less than the first bandwidth.

These and other features and advantages of the present disclosure can be more readily understood from the following embodiments with reference to the appended drawings.

### BRIEF DESCRIPTION OF THE DRAWINGS

FIG. 1 illustrates the device collaboration scheme.

FIG. 2 illustrates the RANK augmentation scheme in accordance with one embodiment of the present disclosure.

FIG. 3 illustrates a method for a wireless device to receive and transmit data in accordance with the embodiment of the present disclosure above.

FIG. 4 illustrates a method for a UE to receive data in accordance with the embodiment of the present disclosure above.

FIG. 5 illustrates the RANK augmentation scheme in accordance with another embodiment of the present disclosure.

### DETAILED DESCRIPTION OF THE DRAWINGS

The present disclosure is not intended to be limited to the embodiments shown below, but is to be accorded the principles disclosed herein. Furthermore, that various modifications or changes in light thereof will be suggested to a person having ordinary skill in the art and are to be included within the spirit and purview of this application and scope of the appended claims.

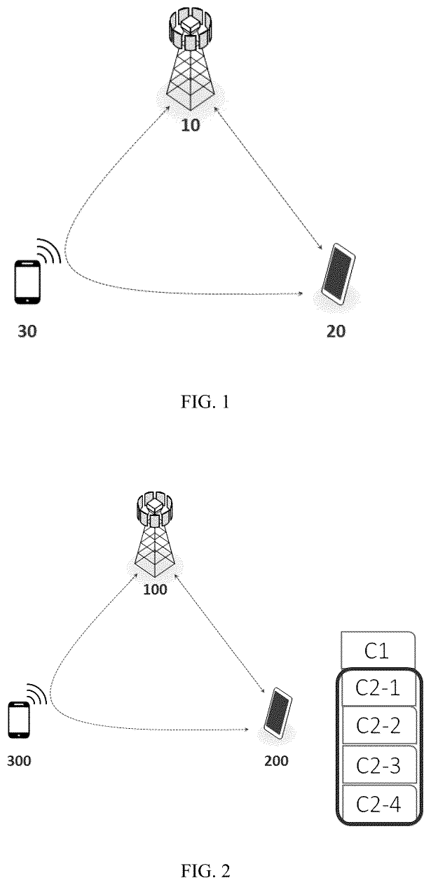

Please refer to FIG. 1, illustrating a device collaboration scheme where a base station 10, a UE 20 and a wireless device 30, such as a wireless relay 30, can wirelessly communicate with each other.

The UE 20 is also called as a Mobile Station MS, such as a mobile phone (also known as a cellular phone or cell phone) or a tablet Personal Computer (PC) with wireless communication capability. The UE 20 may communicate voice and/or data signals with a wireless communication network.

The wireless relay 30 may be a satellite, a watch, a glass, a vehicle, another UE, or any other device having wireless communication capability.

The UE 20 establishes a direct link with the base station 10 and a local link with the wireless relay 30. The available bandwidth provided by the local link is generally larger or equal to that provided by the direct link.

Please refer to FIG. 2, illustrating a device collaboration scheme in accordance with an embodiment of the present disclosure, where a base station 100, the UE 200 and the wireless relay 300 can wirelessly communicate with each other in a wireless communication network. RANK of a channel matrix associated with the base station 100 and the UE 200 is efficiently augmented with the assistance of a wireless relay 300. Details are illustrated as follows.

### The Wireless Relay 300

In addition to the foregoing description of the wireless relay 30 depicted in FIG. 1, the wireless relay 300 depicted in FIG. 2 is further equipped with multiple antennas, such as 2 receiver antennas and 1 transmitter antenna (i.e. 2R1T), in accordance with the embodiment of the present disclosure.

The wireless relay 300 establishes a direct link with the base station 100 and receives one or more RF signals originated and transmitted from the base station 100 at one or two antennas (such as 2R) on a first time-frequency resource. The one or more RF signals on the first time-frequency resource C1 carry a baseband data signal corresponding to L layers of data generated at the base station 100. The L is a positive integer, such as 4, 8, and so on.

The wireless relay 300 then transmits one or more RF signals at the transmitter antenna (such as 1T) on a second time-frequency resource comprising at least two third time-frequency resources to the UE 200. The one or more RF signals on the second time-frequency resource carry the L layers of data generated at the base station 100. In FIG. 2, the second time-frequency resource is illustrated to comprise 4 third time-frequency resources. It means the L layers of data received on one first time-frequency resource C1 are converted and carried by signals occupying four third time-frequency resources C2-1, C2-2, C2-3 and C2-4 to be forwarded to the UE 200 by the wireless relay 300. The signal conversion from the first time-frequency resource to the third time-frequency resources will be presented in detail below.

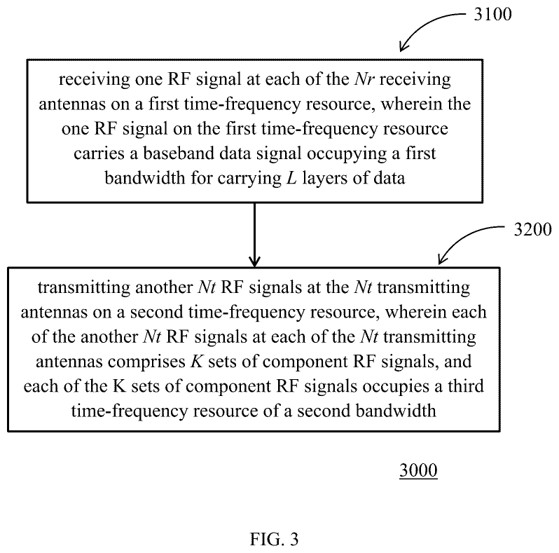

Follows is the wireless relay 300 in generalized presentation accompanying with FIG. 3 which illustrates a method 3000 for a wireless device to receive and transmit data to receive data in accordance with the embodiment of the present disclosure above. A wireless device can receive and transmit data by using Nr receiving antennas and Nt transmitting antennas, where Nr and Nt are positive integers. The wireless device receives one RF signal at each of the Nr receiving antennas on the first time-frequency resource (step 3100), and then transmits another RF signals at the Nt transmitting antennas on a second time-frequency resource (step 3200). The one RF signal on the first time-frequency resource carries a baseband data signal occupying a first bandwidth for carrying L layers of data generated at a node. The another RF signals at the Nt transmitting antennas comprises K sets of component RF signals, wherein K is an integer greater than 1, and each of the K component RF signals occupies a third time-frequency resource of a second bandwidth no less than the first bandwidth. Specifically, the wireless device may refer to the wireless relay 300, the node may refer to the base station 100, the Nr receiving antennas may refer to 4R, the Nt transmitting antennas may refer to 1T, the first time-frequency resource may refer to C1, and the K third time-frequency resources occupied by the K sets of component RF signals may refer to C2-1, C2-2, C2-3 and C2-4 as shown in FIG. 2.

In one example of the embodiment of the present disclosure, the wireless relay 300 performs frequency translation because the bandwidth of a higher frequency band is generally no smaller than that of a lower frequency band. Specifically, the wireless relay 300 shifts one or more carrier frequencies of the one or more RF signals on the first time-frequency resource to each of the one or more third time-frequency resources within the second time-frequency resource to generate the one or more RF signals on the second time-frequency resource.

Follows is the frequency translation in generalized presentation. The K sets of component RF signals are obtained by K linear transformations and K frequency offsets, respectively. Each of the K linear transformations is to linearly combine at least one of the received RF signals at the Nr receiving antennas to generate combined RF signals corresponding to each of the Nt transmitting antennas. Each of the K frequency offsets is to shift carrier frequencies of the combined RF signals.

In one example of the embodiment of the present disclosure, each of the third time-frequency resources C2-1, C2-2, C2-3 and C2-4 and the first time-frequency resource C1 have the same bandwidth and carry the same L layers of data generated at the base station 100. For example, each third time-frequency resource C2-1, C2-2, C2-3 or C2-4 and the first time-frequency resource C1 have a bandwidth of 20 MHz, which means the second time-frequency resource has at least a bandwidth of 80 MHz.

In yet another example of the embodiment of the present disclosure, the wireless relay 300 obtains configuration of K third time-frequency domain resources occupied by the K sets of component RF signals from the base station 100 or the UE 200 because the wireless relay 300 needs to know what kind of configuration of data can be recognized by the UE 200.

### The UE 200

In addition to the foregoing description of the UE 20, the UE 200 further equips multiple antennas, such as 4 receiver antennas and 1 transmitter antenna (i.e. 4R1T), in accordance with the embodiment of the present disclosure.

The UE 200 establishes a direct link with the base station 100 and receives one or more RF signals originated and transmitted from the base station 100 at one or more antennas (4R) on a fourth time-frequency resource. The one or more RF signals on the fourth time-frequency resource C1 carry a baseband data signal corresponding to L layers of data generated at the base station 100. Same as above, the L is a positive integer, such as 4, 8, and so on.

The UE 200 establishes a local link with the wireless relay 300 and receives one or more RF signals at one or more antennas (4R) on a fifth time-frequency resource, wherein the one or more RF signals on the fifth time-frequency resource carry at least two sets of the signals carrying the L layers of data generated at the base station 100, which are received in at least two non-overlapped sixth time-frequency resources within the fifth time-frequency resource. In other words, the one or more RF signals transmitted by the wireless relay 300 at its transmitter antenna (1T) on a second time-frequency resource comprising at least two third time-frequency resources are received by the UE 200 at its antennas (4R) on a fifth time-frequency resource. Specifically, in the embodiment of the present disclosure, the fifth time-frequency resource comprising four sixth time-frequency resources C2-1, C2-2, C2-3 or C2-4 at the receiving side can be corresponded to the second time-frequency resource comprising four third time-frequency resources C2-1, C2-2, C2-3 or C2-4 at the transmitting side.

Accordingly, the UE 200 receives the fourth time-frequency resource C1 carrying a baseband data signal corresponding to L layers of data generated at the base station 100 from the base station 100 and the fifth time-frequency resource comprising four sixth time-frequency resources C2-1, C2-2, C2-3 or C2-4 carrying a baseband data signal corresponding to L layers of data generated at the base station 100 from the wireless relay 300. The UE 200 then obtains one or more baseband signals from the one or more RF signals on the fourth time-frequency resource C1 and obtains one or more baseband signals from the one or more RF signals on the fifth time-frequency resource comprising four sixth time-frequency resources C2-1, C2-2, C2-3 or C2-4 and then determines the L layers of data based on the one or more baseband signals from the one or more RF signals on the fourth time-frequency resource C1 and the one or more baseband signals from the one or more RF signals on the fifth time-frequency resource comprising four sixth time-frequency resources C2-1, C2-2, C2-3 or C2-4.

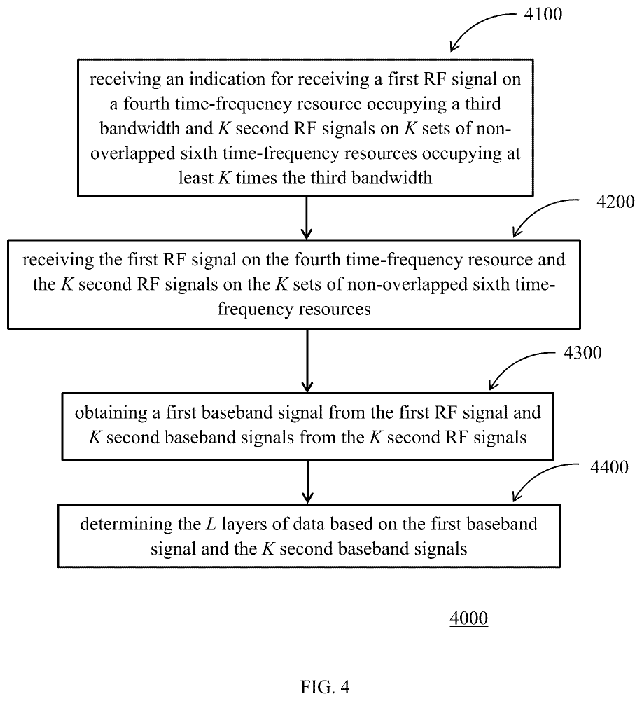

Follows is the UE 200 in generalized presentation accompanying with FIG. 4 which illustrates a method 4000 for a UE to receive data in accordance with the embodiment of the present disclosure above. A UE receives an indication indicating the UE to receive a first RF signal carrying L layers of data on a fourth time-frequency resource occupying a third bandwidth, and to receive K second RF signals each carrying the L layers of data respectively on K sets of non-overlapped sixth time-frequency resources occupying at least K times the third bandwidth, wherein K is a positive integer greater than 1 (step 4100). The UE then receives, based on the indication, the first RF signal at one or more first receiving antennas on the fourth time-frequency resource and the K second RF signals at one or more second receiving antennas respectively on the K sets of non-overlapped sixth time-frequency resources (step 4200). The UE then obtains a first baseband signal from the first RF signal and K second baseband signals from the K second RF signals (step 4300); and determines the L layers of data based on the first baseband signal and the K second baseband signals (step 4400). Specifically, the UE may refer to the UE 200, the fourth time-frequency resource may refer to C1, and the K sets of non-overlapped sixth time-frequency resources may refer to C2-1, C2-2, C2-3 and C2-4 as shown in FIG. 2.

In one example of the embodiment of the present disclosure, the UE 200 receives the indication from the base station 100 because the UE 200 needs to know how to receive and interpret the RF signals sent from the base station 100 and the wireless station 300. However, in another example of the embodiment of the present disclosure, the UE 200 may receive the indication from the wireless relay 300 as well.

In one example of the embodiment of the present disclosure, each of the K sets of non-overlapped sixth time-frequency resources occupying a bandwidth no less than the third bandwidth. For example, assume the fourth time-frequency resource occupies a bandwidth of 20 MHz, and then each of the K sets of non-overlapped sixth time-frequency resources occupies a bandwidth no less than 20 MHz.

In one example of the embodiment of the present disclosure, the one or more RF signals on the first time-frequency resource and the one or more RF signals on the second time-frequency resource are received within the same time slot.

In one example of the embodiment of the present disclosure, the first time-frequency resource and the second time-frequency resource do not overlap with each other.

In one example of the embodiment of the present disclosure, the L is larger than the number of the one or more RF signals on the first time-frequency resource. For example, the L may be 8 and the number of receiver antennas of the UE 200 may be 4 in which the RF signals on the first time-frequency resource may be 2.

In one example of the embodiment of the present disclosure, one of the first receiving antennas and one of the second receiving antennas may be the same physical antenna. However, in another example of the embodiment of the present disclosure, the first receiving antennas and the second receiving antennas may be different physical antennas.

In one example of the embodiment of the present disclosure, the at least two non-overlapped sixth time-frequency resources are at least two non-overlapped component carriers (CC), which means the K sets of non-overlapped sixth time-frequency resources are K sets of non-overlapped component carriers (CC).

In one example of the embodiment of the present disclosure, the at least two non-overlapped sixth time-frequency resources are at least two non-overlapped sets of resource blocks within a component carrier (CC), which means the K sets of non-overlapped sixth time-frequency resources are K non-overlapped sets of resource blocks within a component carrier (CC).

In one example of the embodiment of the present disclosure, the UE 200 wirelessly communicates with the base station 100 in a wireless communication network, and wherein the number of the at least two sets of the signals carrying the L layers of data generated at the base station 100 is decided by the wireless communication network.

It should be noted that the number of the sets of the signals carrying the L layers of data generated at the base station 100 is unnecessarily equal to the number of the receiver antennas of the UE 200.

### Rank

Given the above, under the condition that the base station 100 is assumed to have B_{T} transmitter antennas (B_{T}=8) and is capable of sending RF signals carrying RANK-8 baseband signals, the UE 200 is assumed to have U_{R} receiver antennas (U_{R}=4) and U_{T} transmitter antenna (U_{T}=1) (i.e. 4R1T). The wireless relay 300 is also assumed to have W_{R} receiver antennas (W_{R}=4) and W_{T} transmitter antenna (W_{T}=1) (i.e. 4R1T), and it is supposed to transmitted signals in four sidebands by the W_{T} transmitter antennas. Different frequency offsets are applied so that the four sidebands are non-overlapped. The signals generated for the four sidebands are combined for transmission by the wireless relay 300. The wireless relay 300 is designed to keep the following matrix as a high-RANK matrix.

$$[ \begin{matrix}{H}_{3 , {s}_{1}} {G}_{{s}_{1} 1 \times 4} \\ {H}_{3 , {s}_{2}} {G}_{{s}_{2} 1 \times 4} \\ {H}_{3 , {s}_{3}} {G}_{{s}_{3} 1 \times 4} \\ {H}_{3 , {s}_{4}} {G}_{{s}_{4} 1 \times 4}\end{matrix} ]$$

The H₃, sᵢ above means the transmission matrix between the wireless relay 300 and the UE 200 for each of four sidebands s₁, s₂, s₃, and s₄, and the Gsᵢ above means signals received at all of the receiver antennas in the i-th sideband are amplified by the gain matrix Gsᵢ. In other words, signal transmitted by the W_{T}=1 antenna in the i^{th} sideband is a linear combination of signals received at all of the receiver antennas. In one particular example, the gain matrix Gsᵢ is given by:

$${G}_{{s}_{i} 1 \times 4} = {g}_{i} \cdot {\vec{e}}_{i}^{H}$$

In this example, assuming that the G above are respectively [1, 0, 0, 0], [0, 1, 0, 0], [0, 0, 1, 0] and [0, 0, 0, 1] as follows, the RF signal received at the i^{th} receiver antenna (i is equal to 1, 2, 3 and 4) (W_{R}=4) on the first time-frequency resource is used to generate the RF signal in the i^{th} sideband to be transmitted at the transmitter antenna (W_{T}=1) on the second time-frequency resource.

$${G}_{{s}_{1} 1 \times 4} = [ 1 , 0 , 0 , 0 ]$$

$${G}_{{s}_{2} 1 \times 4} = [ 0 , 1 , 0 , 0 ]$$

$${G}_{{s}_{3} 1 \times 4} = [ 0 , 0 , 1 , 0 ]$$

$${G}_{{s}_{4} 1 \times 4} = [ 0 , 0 , 0 , 1 ]$$

In addition, the UE 200 is designed to have a high-RANK matrix with the assistance of the wireless relay 300 as follows.

$${r}_{20 \times 1} = [ \begin{matrix}{[ {H}_{{1}_{4 \times 8}} \cdot {P}_{8 \times 8} ]}_{4 \times 8} \\ {H}_{3 , {s}_{1}} {{G}_{{s}_{1} 1 \times 4} [ {H}_{{2}_{4 \times 8}} \cdot {P}_{8 \times 8} ]}_{4 \times 8} \\ {H}_{3 , {s}_{2}} {{G}_{{s}_{2} 1 \times 4} [ {H}_{{2}_{4 \times 8}} \cdot {P}_{8 \times 8} ]}_{4 \times 8} \\ {H}_{3 , {s}_{3}} {{G}_{{s}_{3} 1 \times 4} [ {H}_{{2}_{4 \times 8}} \cdot {P}_{8 \times 8} ]}_{4 \times 8} \\ {H}_{3 , {s}_{4}} {{G}_{{s}_{4} 1 \times 4} [ {H}_{{2}_{4 \times 8}} \cdot {P}_{8 \times 8} ]}_{4 \times 8}\end{matrix} ] {x}_{8 \times 1} = [ \begin{matrix}{H}_{{1}_{4 \times 8}} \\ [ \begin{matrix}{H}_{3 , {s}_{1}} {G}_{{s}_{1} 1 \times 4} \\ {H}_{3 , {s}_{2}} {G}_{{s}_{2} 1 \times 4} \\ {H}_{3 , {s}_{3}} {G}_{{s}_{3} 1 \times 4} \\ {H}_{3 , {s}_{4}} {G}_{{s}_{4} 1 \times 4}\end{matrix} ] \cdot {H}_{{2}_{4 \times 8}}\end{matrix} ] {P}_{8 \times 8} \cdot {x}_{8 \times 1}$$

The r_{20×1} means baseband receiving vector at UE 200, x_{8×1} means the transmitting vector at the base station 100, and the matrix above mean the transmission matrix between the base station 100 and the UE 200 with the assistance of the wireless relay 300. The H₁ above means the transmission matrix between the base station 100 and the UE 200 without the assistance of the wireless relay 300. The H₂ above means the transmission matrix between the base station 100 and the wireless relay 300.

The first to fourth rows of the matrix above means the direct link established between the base station 100 and the UE 200 and the fifth to eighth rows of the matrix above means the direct link established between the base station 100 and the wireless relay 300 and the local link established between the wireless relay 300 and the UE 200. The wireless relay 300 is a relay node forwarding data transmitted from the base station 100 to the UE 200.

The RANK of H₁ is typically limited by the number of receiver antennas of the UE 100, i.e. U_{R}=4 without the assistance of the wireless relay 300. However, the RANK of the matrix above between the base station 100 and the UE 200 can be augmented to 8 with the assistance of the wireless relay 300 under the condition that the RF signal received at the i^{th} receiver antenna (i is equal to 1, 2, 3 and 4) (W_{R}=4) on the first time-frequency resource are linearly combined to generate the RF signal comprising four sidebands to be transmitted at the transmitter antenna (W_{T}=1) on the second time-frequency resource.

However, again it should be noted that the RF signal received at the one or more receiver antennas of the wireless relay 300 on the first time-frequency resource are linearly combined to generate the RF signal comprising at least two sidebands corresponding to the at least two sets of the signals carrying the L layers of data generated at the base station 100 to be transmitted at the transmitter antenna of the wireless relay 300 on the second time-frequency resource, the RANK of the transmission matrix between the base station 100 and the UE 200 is augmented to at least 6 (4 plus 2) with the assistance of the wireless relay 300.

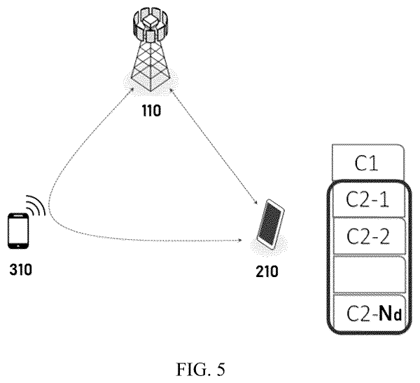

Now please refer to FIG. 5, illustrating a UE 210 that augments RANK with the assistance of a wireless relay 310 under the device collaboration scheme where a base station 110, the UE 210 and the wireless relay 310 can wirelessly communicate with each other in a wireless communication network in accordance with another embodiment of the present disclosure.

The UE 210 receives Nr1 RF signals transmitted from the base station 110 at Nr1 antennas on a first time-frequency resource C1, wherein the Nr1 RF signals carry L layers of data generated at the base station 110. The UE 210 also receives Nr2 RF signals transmitted from the wireless relay at Nr2 antennas on a second time-frequency resource, wherein the Nr2 RF signals comprises Nd third time-frequency resources within the second time-frequency resource C2-1, C2-2, . . . , C2-Nd, and each of the third time-frequency resources C2-1, C2-2, . . . , and C2-Nd carries the L layers of data generated at the base station 110. The UE 210 then obtains Nr1 baseband signals and Nr2 baseband signals respectively from Nr1 RF signals and Nr2 RF signals; and determines the L layers of data based on the Nr1 baseband signals and Nr2 baseband signals. The Nr1, Nr2, Nd and L are positive integers.

In one example of the embodiment of the present disclosure, Nd is larger than two.

In one example of the embodiment of the present disclosure, the Nr1 RF signals and Nr2 RF signals are received within the same time slot.

In one example of the embodiment of the present disclosure, the first time-frequency resource C1 and the second time-frequency resource, comprising the third time-frequency resources C2-1, C2-2, . . . , and C2-Nd, do not overlap with each other.

In one example of the embodiment of the present disclosure, the L is larger than Nr1. For example, the L may be 8 and Nr1 is 4.

In one example of the embodiment of the present disclosure, the Nd non-overlapped third time-frequency resources are Nd non-overlapped component carriers (CC).

In one example of the embodiment of the present disclosure, the Nd non-overlapped third time-frequency resources are Nd non-overlapped sets of resource blocks within a component carrier (CC).

In one example of the embodiment of the present disclosure, the UE 210 wirelessly communicates with the base station 110 in a wireless communication network, and wherein Nd is decided and given by the wireless communication network. For example, the wireless communication network may assign Nd as 2 or 3 to the wireless relay 310. The UE 200 and the wireless relay 310 can both receive Nd from the wireless communication network.

The RANK of a transmission matrix between the base station 110 and the UE 210 is augmented by Nd with the assistance of the wireless relay 310 for a case with W_{T}=1. For example, assuming the RANK of a transmission matrix between the base station 110 and the UE 210 is equal to 4, which is the number of the receiver antennas of the UE 210, without the existence of the wireless relay 310, the RANK will become 4+Nd with the assistance of the wireless relay 310. More generally, for cases with W_{T}>1, the RANK can be up to 4+W_{T}·Nd with the assistance of the wireless relay 310.

The embodiments of the present invention have been described above. However, those having ordinary skill in the art readily recognize that the disclosure described above can be utilized in a variety of devices, environments, and situations. Although the present invention is written with respect to specific embodiments and implementations, various changes and modifications may be suggested to a person having ordinary skill in the art. It is intended that the present disclosure encompass such changes and modifications that fall within the scope of the appended claims.

For example, those having ordinary skill in the art would understand that a device may include a processor, memory in electronic communication with the processor, and instructions stored in the memory. The instructions are used to perform the methods in accordance with the embodiments above.

In addition, those having ordinary skill in the art would also understand that a system may include a base station, a UE and a wireless relay or a plurality of wireless relays. The system is capable of performing the methods in accordance with the embodiments above.

What is claimed is:

1. A method for a User Equipment (UE) to receive data, the method comprising:
receiving an indication indicating the UE to receive a first RF signal carrying L layers of data on a first time-frequency resource occupying a first bandwidth, wherein L is a positive integer, and to receive K second RF signals each carrying the L layers of data respectively on K sets of non-overlapped second time-frequency resources occupying at least K times the first bandwidth, wherein K is a positive integer greater than 1;
receiving, based on the indication, the first RF signal at one or more first receiving antennas on the first time-frequency resource and the K second RF signals at one or more second receiving antennas respectively on the K sets of non-overlapped second time-frequency resources;
obtaining a first baseband signal from the first RF signal and K second baseband signals from the K second RF signals; and
determining the L layers of data based on the first baseband signal and the K second baseband signals.

2. The method of claim 1, wherein each of the K sets of non-overlapped second time-frequency resources occupying a bandwidth no less than the first bandwidth.

3. The method of claim 1, wherein the first RF signal on the first time-frequency resource and the K RF signals on the second time-frequency resource are received within the same time slot.

4. The method of claim 1, wherein the first time-frequency resource and the second time-frequency resource do not overlap with each other.

5. The method of claim 1, wherein the L is larger than the number of the first receiving antennas on the first time-frequency resource.

6. The method of claim 1, wherein one of the first receiving antennas and one of the second receiving antennas is the same physical antenna.

7. The method of claim 1, wherein the K sets of non-overlapped second time-frequency resources are K sets of non-overlapped component carriers (CC).

8. The method of claim 1, wherein the K sets of non-overlapped second time-frequency resources are K sets of non-overlapped resource blocks within a component carrier (CC).

9. The method of claim 1, wherein the indication is sent from a node, and wherein the node is a base station or a wireless device.

10. A method for a wireless device to receive and transmit data by using Nr receiving antennas and Nt transmitting antennas, wherein Nr and Nt are positive integers, the method comprising:
receiving one RF signal at each of the Nr receiving antennas on a first time-frequency resource, wherein the one RF signal on the first time-frequency resource carries a baseband data signal occupying a first bandwidth for carrying L layers of data generated at a node, and the L is a positive integer; and
transmitting another Nt RF signals at the Nt transmitting antennas on a second time-frequency resource, wherein each of the another Nt RF signals at each of the Nt transmitting antennas comprises K sets of component RF signals, wherein K is an integer greater than 1, and each of the K sets of component RF signals occupies a third time-frequency resource of a second bandwidth no less than the first bandwidth.

11. The method of claim 10, wherein the K sets of component RF signals are obtained according to K linear transformations and K frequency offsets, respectively.

12. The method of claim 11, wherein each of the K linear transformations comprises combining at least one of the received RF signals at the Nr receiving antennas linearly to generate combined RF signals corresponding to the Nt transmitting antennas.

13. The method of claim 12, wherein each of the K frequency offsets comprises shifting carrier frequencies of the combined RF signals.

14. The method of claim 10, wherein the first bandwidth and the second bandwidth are equal.

15. The method of claim 10, wherein the third time-frequency resource and the first time-frequency resource carry the same L layers of data generated at the node.

16. The method of claim 10, wherein the wireless device receives data from the node by using the Nr receiving antennas and transmits data to a User Equipment (UE) by using the Nt transmitting antennas.

17. The method of claim 16, the method further comprising obtaining configuration of K third time-frequency domain resources occupied by the K sets of component RF signals from the node.

18. The method of claim 16, the method further comprising obtaining configuration of K third time-frequency domain resources occupied by the K sets of component RF signals from the UE.

19. The method of claim 10, the node is a base station or a wireless device.
